(19) United States
(12) Patent Application Publication
(10) Pub. No.: US 2011/0102406 A1
(43) Pub. Date: May 5, 2011

(54) GATE DRIVER AND OPERATING METHOD THEREOF

(76) Inventors: Chien-Kuo Wang, Zhubei City (TW); Kuo-Jung Wang, Anding Township (TW); Wei-Ming Chen, Kaohsiung City (TW); Chin-Chieh Chao, Hsinchu City (TW)

(21) Appl. No.: 12/939,722

(22) Filed: Nov. 4, 2010

(30) Foreign Application Priority Data
Nov. 5, 2009 (TW) 098137547

(51) Int. Cl. G06F 3/038

(52) U.S. Cl. 345/211

(57) ABSTRACT

A gate driver applied to a LCD apparatus is disclosed. The gate driver includes a pulse modulation controlling module. When a pulse modulation controlling signal received by the pulse modulation controlling module is changed from a high level to a low level, the pulse modulation controlling module closes an active switch according to the pulse modulation controlling signal, so that a high level power signal will begin discharging to have a modulated pulse form.

### BACKGROUND OF THE INVENTION

1. Field of the Invention

The invention relates to a display apparatus, particularly to a gate driver of a LCD display and a method of operating the gate driver.

2. Description of the Prior Art

In recent years, the image display related technology has continuously developed; the conventional CRT (Cathode Ray Tube) display has been gradually replaced by various new-type display apparatuses shown on the market. Among these display apparatuses, because the liquid crystal displayer has advantages of saving power and small size, therefore, the liquid crystal displayer is widely used by ordinary consumers and becomes the mainstream of the displayer market.

Please refer to FIG. 1. FIG. 1 illustrates a schematic diagram of the operation of a power source management chip and a gate driver of a conventional LCD apparatus. As shown in FIG. 1, the power source management chip 1 conventionally used in the LCD apparatus mainly includes a boost regulator 10 and a modulated pulse generator 12. Wherein, the boost regulator 10 is used to boost a lower level input power source VIN to a higher level analog main power source AVDD. The analog main power source AVDD is used to provide the power needed by a source driver, a Gamma reference voltage buffer, a first charge pump 2, and a second charge pump 3. The first charge pump 2 and the second charge pump 3 will generate a high-level output power VGH and a lower-level output power VGL respectively to the gate drivers 5.

In general, after a signal is transmitted by scanning lines of the LCD apparatus, the waveform of the signal will be distorted due to the delay of parasitic resistance and parasitic capacitance, the waveform of the signal of the front and end gate driver 5 will be different from others, so that LCD display flicker will be caused. In order to improve this flicker condition, the high-level output power VGH outputted by the first charge pump 2 will not be directly provided to the gate driver 5; instead, the high-level output power VGH will be modulated by a modulated pulse generator 12 of the power source management chip 1 according to a level of pulse modulation control signal YVC to generate a pulse modulation output power signal VGHM, and then the pulse modulation output power signal VGHM will be outputted to the gate drivers 5.

Please refer to FIG. 2. FIG. 2 illustrates an example of the modulated pulse generator 12 of the conventional power source management chip 1. As shown in FIG. 2, the modulated pulse generator 12 uses two PMOS (P1 and P2) as the switches, and a discharging node RE is coupled to a discharging resistor R1. When the pulse modulation control signal YVC is at high-level, the reverse signal YVC_N of the pulse modulation control signal YVC will be at low-level; at this time, the switch P1 will be on and the switch P2 will be off, so that the pulse modulation output power signal VGHM will be charged to the high-level output power VGH. When the pulse modulation control signal YVC is at low-level, the reverse signal YVC_N of the pulse modulation control signal YVC will be at high-level, at this time, the switch P1 will be off and the switch P2 will be on, so that the pulse modulation output power signal VGHM will start to discharge from the high-level output power VGH via the ground discharging resistor R1.

Although the above-mentioned method can improve the flicker condition of the LCD display, other problems hard to overcome will be caused. Please refer to FIG. 3. FIG. 3 shows a timing diagram of the operation of the conventional modulated pulse generator 12. As shown in FIG. 3, it is assumed that the high-level output power VGH is 30 V, the voltage of modulated pulse bottom is 10 V. During a first time interval t1, the switch P1 is off and the switch P2 is on, the pulse modulation output power signal VGHM will discharge to the discharging node RE to form a modulated waveform.

Then, after the time enters into the second time interval t2, the switch P1 is switched from the off-state to the on-state, and the switch P2 is switched from on-state to the off-state. Because the ordinary switches P1 and P2 has a resistance of 15 Ohm or less, therefore, a pulse will be generated at the moment that the switch P1 is switched from the off-state to the on-state, and its peak value is (30V-10V)/15 Ohm=1.3 A.

It should be noticed that with the increasing of the size of the panel of the LCD apparatus, the number of the channels of the gate driver will be increased, so that the loading capacitance of the pulse modulation output power signal VGHM will become larger, and the maintaining time of the pulse current formed when the switch P1 is turned on will become longer. On the other hand, the high-level output power VGH of the gate driver will be raised with the increasing of the size of the panel. Under the condition that the voltage of modulated pulse bottom stays unchanged, the peak value of the pulse current will become larger, so that the gate driver and its package circuit will be damaged. In addition, in order to integrate the boost regulator 10 and the gate pulse modulation switch 12 made by processes of different voltages in the same conventional power source management chip 1, a lot of additional design cost will be spent and it is inconvenient for users.

Therefore, the invention provides a gate driver applied in a LCD apparatus and operating method thereof to solve the above-mentioned problems.

### SUMMARY OF THE INVENTION

A first embodiment of the invention is a gate driver. The gate driver is applied in a LCD apparatus, and the gate driver includes a pulse modulation controlling module, an output buffering module, a first charge pump, and a second charge pump. The pulse modulation controlling module includes a pulse modulation controlling logic unit and an active switch. The first charge pump and the second charge pump are used to receive a low-voltage power source and generate a high-level power source signal and a low-level power source signal respectively. When a pulse modulation controlling signal received by the pulse modulation controlling logic unit changes from high-level to low-level, the pulse modulation controlling logic unit will perform a logic operation process according to a level shifting signal and the pulse modulation controlling signal to generate a first switch signal and a second switch signal respectively to turn off the active switch and the output buffering module, so that the high-level power source signal will start to discharge and have a modulated waveform.

A second embodiment of the invention is a gate driver. Different from the gate driver of the above-mentioned first embodiment, in the gate driver of the second embodiment, the duty cycle of the system clock signal will be probably designed to match the duty cycle of the pulse modulation controlling signal; therefore, the system clock signal can be directly used to replace the original pulse modulation controlling signal to further simplify the design of the panel system.

A third embodiment of the invention is a gate driver operating method. The gate driver is applied in a LCD apparatus, and the gate driver includes a pulse modulation controlling module, an output buffering module, a first charge pump, and a second charge pump. The pulse modulation controlling module includes a pulse modulation controlling logic unit and an active switch.

At first, the first charge pump and the second charge pump receive a low-voltage power source and generate a high-level power source signal and a low-level power source signal respectively. When a pulse modulation controlling signal received by the pulse modulation controlling logic unit changes from high-level to low-level, the pulse modulation controlling logic unit will perform a logic operation process according to a level shifting signal and the pulse modulation controlling signal to generate a first switch signal and a second switch signal respectively. Then, the active switch and the output buffering module are turned off according to the first switch signal and the second switch signal respectively to make the high-level power source signal start to discharge to form a modulated waveform.

The advantage and spirit of the invention may be understood by the following recitations together with the appended drawings.

### BRIEF DESCRIPTION OF THE APPENDED DRAWINGS

FIG. 1 illustrates a schematic diagram of the operation of a power source management chip and a gate driver of a conventional LCD apparatus.

FIG. 2 illustrates an example of the modulated pulse generator of the conventional power source management chip.

FIG. 3 illustrates a timing diagram of the operation of the conventional modulated pulse generator.

FIG. 4 illustrates a functional block diagram of the gate driver of the first embodiment in the invention.

FIG. 5 illustrates a detailed functional block diagram of the pulse modulation controlling module shown in FIG. 4.

FIG. 6 illustrates a timing diagram of the operation of the pulse modulation controlling module shown in FIG. 4.

FIG. 7 illustrates a functional block diagram of the gate driver of the second embodiment in the invention.

FIG. 8 illustrates a detailed functional block diagram of the pulse modulation controlling module shown in FIG. 7.

FIG. 9 illustrates a timing diagram of the operation of the pulse modulation controlling module shown in FIG. 7.

FIG. 10 illustrates a flowchart of the gate driver operating method of the third embodiment in the invention.

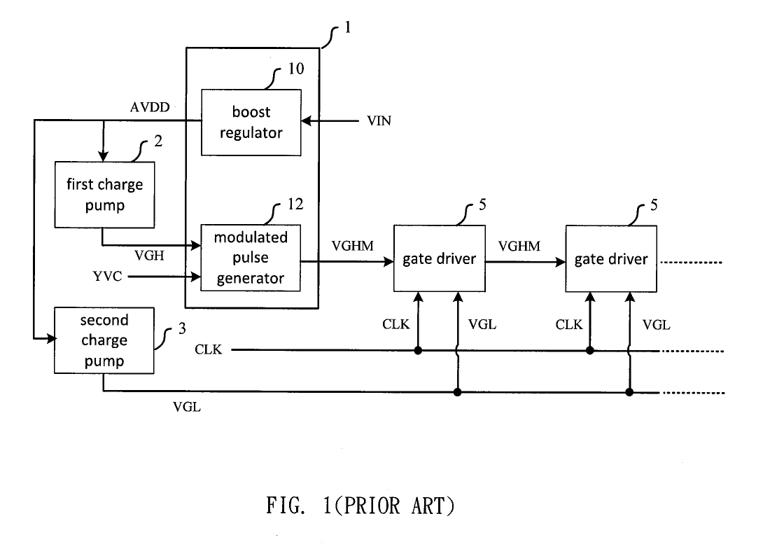

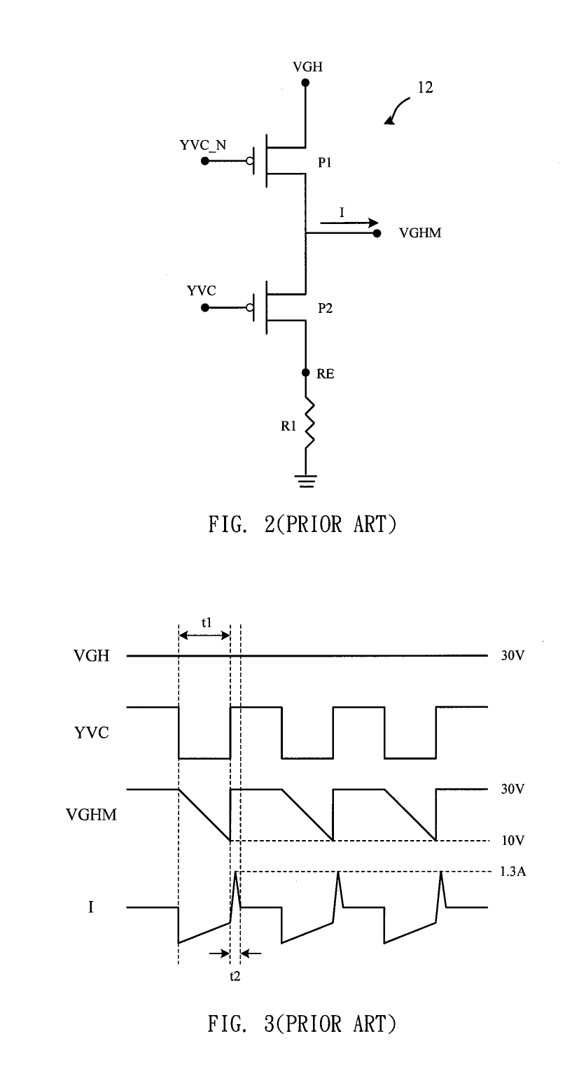

### DETAILED DESCRIPTION OF THE INVENTION

The invention provides a gate driver applied in a LCD apparatus and operating method thereof. The gate driver of the invention can not only effectively prevent the damage to the gate driver caused by the pulse current formed when the conventional power source management chip generates a modulated pulse, but also have advantages of using single power source, reducing signal types, and simplifying the design of the power source management chip, therefore, the entire cost of the panel display system can be largely reduced to enhance its competitiveness on the market.

A first embodiment of the invention is a gate driver. In this embodiment, the gate driver can be applied in the LCD apparatus, but not limited to this case. The same with the prior art, the LCD apparatus also includes a power source management chip and a gate driver. However, it should be noticed that since the pulse modulation output power source outputted to the gates is generated by the gate driver in the invention, when the power source management chip is designed, only the manufacturing process suitable for the boost regulator (e.g., the manufacturing process of 20V voltage) should be considered, so that the chip design cost will be largely reduced and the flexibility of selecting manufacturing processes can be also increased.

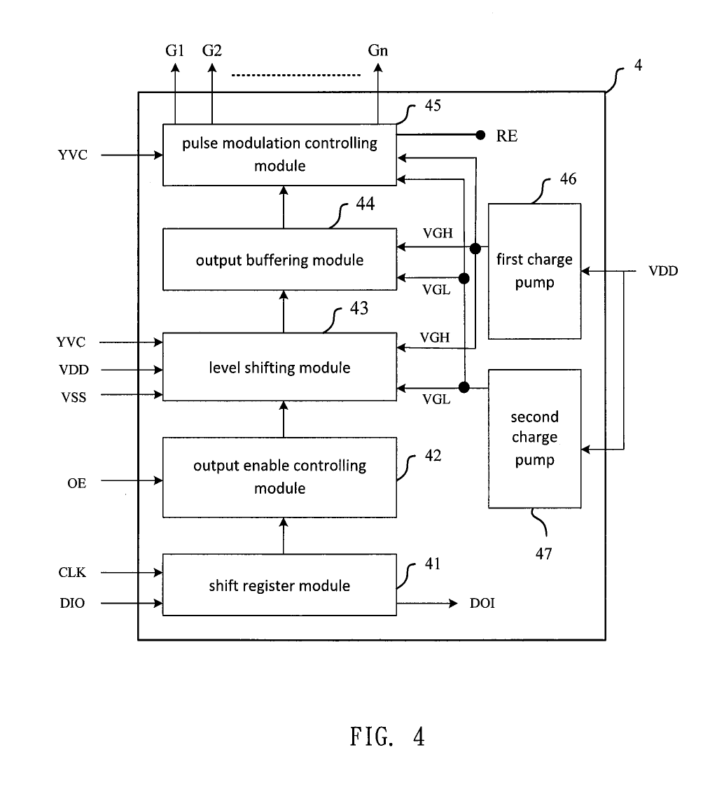

Please refer to FIG. 4. FIG. 4 illustrates a functional block diagram of the gate driver of the first embodiment in the invention. As shown in FIG. 4, the gate driver 4 includes a shift register module 41, an output enable controlling module 42, a level shifting module 43, an output buffering module 44, a pulse modulation controlling module 45, a first charge pump 46, and a second charge pump 47. Wherein, the shift register module 41 is coupled to the output enable controlling module 42; the output enable controlling module 42 is coupled to the level shifting module 43; the level shifting module 43 is coupled to the output buffering module 44; the output buffering module 44 is coupled to the pulse modulation controlling module 45; the pulse modulation controlling module 45 is coupled to n gates G1˜Gn, n is a positive integer; the first charge pump 46 and the second charge pump 47 are coupled to the level shifting module 43 and the output buffering module 44 respectively.

It should be noticed that since the shift register module 41, the output enable controlling module 42, the level shifting module 43, and the output buffering module 44 are well-known modules of the gate driver 4, there is no further related description. Next, the pulse modulation controlling module 45, the first charge pump 46, and the second charge pump 47 will be introduced in detail.

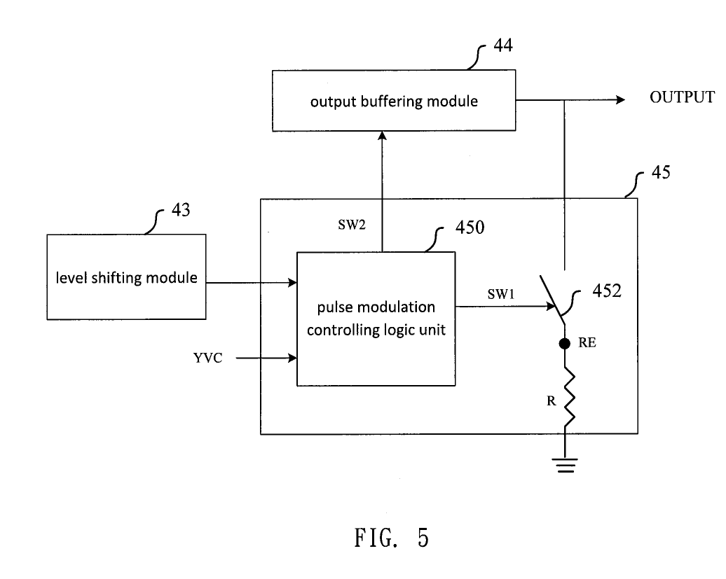

Please refer to FIG. 5. FIG. 5 illustrates a detailed functional block diagram of the pulse modulation controlling module 45. As shown in FIG. 5, the pulse modulation controlling module 45 includes a pulse modulation controlling logic unit 450, an active switch 452, and a discharging node RE. The discharging node RE is ground through a discharging resistor R to adjust the pulse modulation depth. In fact, the discharging node RE can directly ground or connect to other devices in series, there is no specific limitations.

In this embodiment, after the pulse modulation controlling logic unit 450 receives a level shifting signal from the level shifting module 43 and performs a logic operation process according to the level shifting signal and a pulse modulation controlling signal YVC, a first switch signal SW1 and a second switch signal SW2 will be generated respectively to control the active switch 452 and the output buffering module 44 turned on or off respectively.

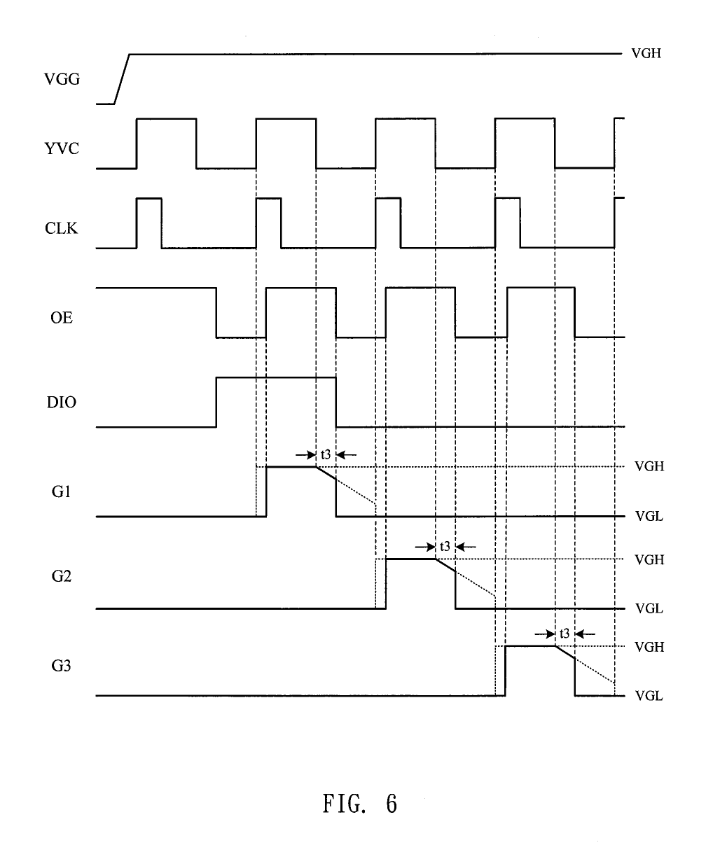

Please refer to FIG. 6. FIG. 6 illustrates a timing diagram of the operation of the pulse modulation controlling module 45. As shown in FIG. 6, when the time starts to enter into the third time interval t3, the pulse modulation controlling signal YVC changes from high-level to low-level, at this time, the pulse modulation controlling logic unit 450 will output the first switch signal SW1 and the second switch signal SW2 to the active switch 452 and the output buffering module 44 respectively according to the level shifting signal and the pulse modulation controlling signal YVC to turn off the active switch 452 and the output buffering module 44 respectively.

When the active switch 452 is turned off, the corresponding first gate output will start to discharge through the discharging path of the discharging node RE and the ground discharging resistor R to obtain a first output power source signal G1 with a modulated waveform. Until an output enable signal OE changes from high-level to low-level, the first output power source signal G1 will start to stay at the low voltage level VGL. Similarly, other gate outputs will also discharge during the third time interval t3 and obtain the output power source signal with the modulated waveform, for example, the second output power source G2 and the third output power source G3, and so on.

It should be noticed that according to the driving theorem of the LCD apparatus, there will be only one channel of the gate driver 4 open at the same time, the high-voltage level VGH and the low-voltage level VGL outputted by the gate driver 4 do not pump too much current, so that the gate driver 4 can effectively prevent the damage to the gate driver caused by the pulse current formed when the conventional power source management chip generates the modulated pulse.

In addition, as shown in FIG. 4, the gate driver 4 only needs a low-level power source VDD provided from outside, and then the gate driver 4 can use its first charge pump 46 and second charge pump 47 to form the outputted high-voltage level VGH and low-voltage level VGL, so that the chip design with single power source can be achieved, it is very convenient and low cost for designing panel system.

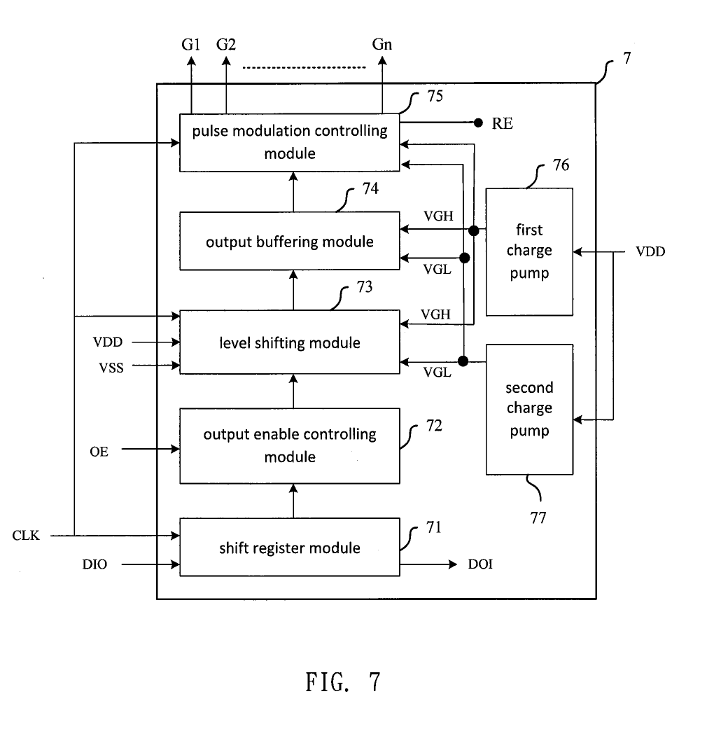

A second embodiment of the invention is also a gate driver. Please refer to FIG. 7. FIG. 7 illustrates a functional block diagram of the gate driver. As shown in FIG. 7, the gate driver 7 includes a shift register module 71, an output enable controlling module 72, a level shifting module 73, an output buffering module 74, a pulse modulation controlling module 75, a first charge pump 76, and a second charge pump 77. Wherein, the shift register module 71 is coupled to the output enable controlling module 72; the output enable controlling module 72 is coupled to the level shifting module 73; the level shifting module 73 is coupled to the output buffering module 74; the output buffering module 74 is coupled to the pulse modulation controlling module 75; the pulse modulation controlling module 75 is coupled to n gates G1˜Gn, n is a positive integer; the first charge pump 76 and the second charge pump 77 are coupled to the level shifting module 73 and the output buffering module 74 respectively.

It should be noticed that in order to further simplify the design of panel system and reduce signal types, the pulse modulation controlling signal YVC of the first embodiment will be replaced by the system clock signal CLK. In fact, if the duty cycle of the system clock signal CLK is suitably designed to be the same with that of the pulse modulation controlling signal YVC, the system clock signal CLK can be directly used as the pulse modulation controlling signal.

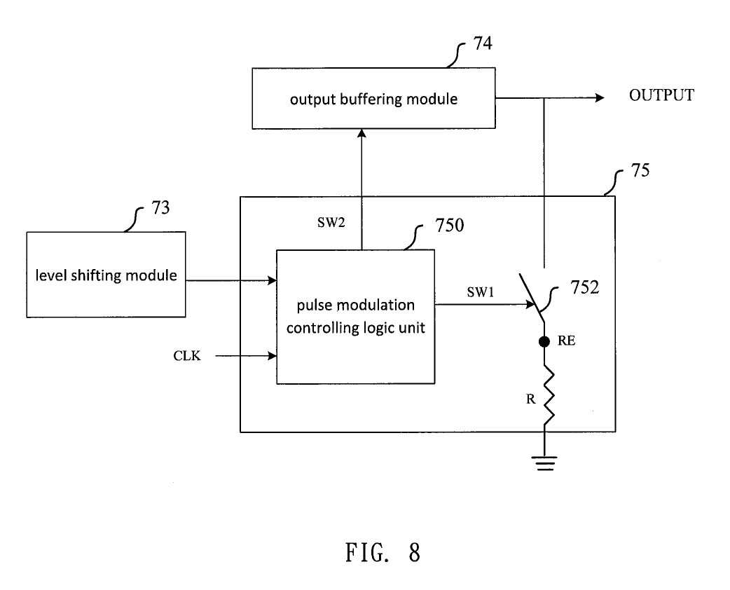

Please refer to FIG. 8. FIG. 8 illustrates a detailed functional block diagram of the pulse modulation controlling module 75. As shown in FIG. 8, the pulse modulation controlling module 75 includes a pulse modulation controlling logic unit 750, an active switch 752, and a discharging node RE. The discharging node RE is ground through a discharging resistor R to adjust the pulse modulation depth. In fact, the discharging node RE can directly ground or connect to other devices in series, there is no specific limitations.

In this embodiment, after the pulse modulation controlling logic unit 750 receives a level shifting signal from the level shifting module 73 and performs a logic operation process according to the level shifting signal and a system clock signal CLK, a first switch signal SW1 and a second switch signal SW2 will be generated respectively to control the active switch 752 and the output buffering module 74 turned on or off respectively.

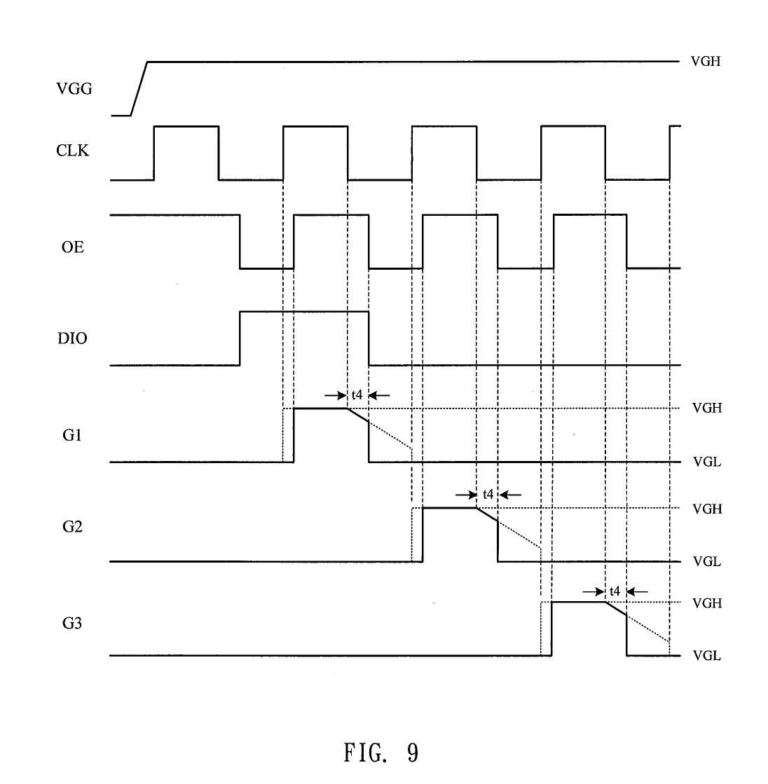

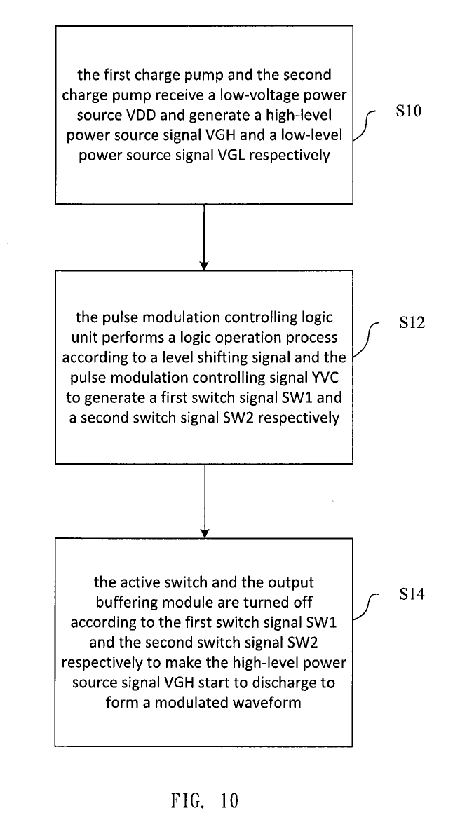

Please refer to FIG. 9. FIG. 9 illustrates a timing diagram of the operation of the pulse modulation controlling module 75. As shown in FIG. 9, when the time starts to enter into the fourth time interval t4, the pulse modulation controlling signal YVC changes from high-level to low-level, at this time, the pulse modulation controlling logic unit 750 will output the first switch signal SW1 and the second switch signal SW2 to the active switch 752 and the output buffering module 74 respectively according to the level shifting signal and the system clock signal CLK to turn off the active switch 752 and the output buffering module 74 respectively.

When the active switch 752 is turned off, the corresponding first gate output will start to discharge to obtain a first output power source signal G1 with a modulated waveform. Until an output enable signal OE changes from high-level to low-level, the first output power source signal G1 will start to stay at the low voltage level VGL. Similarly, other gate outputs will also discharge during the fourth time interval t4 and obtain the output power source signal with the modulated waveform, for example, the second output power source G2 and the third output power source G3, and so on.

Above all, the gate driver 7 of this embodiment not only has advantages of preventing pulse current damage and single power source chip design, but also can use the original system clock signal CLK to replace the pulse modulation controlling signal YVC, so that the design of the panel system can be further simplified to enhance the competitiveness of the LCD apparatus including the gate driver 7 on the market.

A third embodiment of the invention is a gate driver operating method. In this embodiment, the gate driver is applied in a LCD apparatus. The gate driver includes a pulse modulation controlling module, an output buffering module, a first charge pump, and a second charge pump. The pulse modulation controlling module includes a pulse modulation controlling logic unit and an active switch, but not limited to this case. The same with the prior art, the LCD apparatus also includes a power source management chip and a gate driver.

It should be noticed that since the pulse modulation output power source outputted to the gates is generated by the gate driver in the invention, when the power source management chip is designed, only the manufacturing process suitable for the boost regulator (e.g., the manufacturing process of 20V voltage) should be considered, so that the chip design cost will be largely reduced and the flexibility of selecting manufacturing processes can be also increased.

Please refer to FIG. 10. FIG. 10 illustrates a flowchart of the gate driver operating method of the third embodiment in the invention. As shown in FIG. 10, at first, the step S10 is preformed, the first charge pump and the second charge pump receive a low-voltage power source VDD and generate a high-level power source signal VGH and a low-level power source signal VGL respectively. When a pulse modulation controlling signal YVC changes from high-level to low-level, the step S12 is performed, the pulse modulation controlling logic unit performs a logic operation process according to a level shifting signal and the pulse modulation controlling signal YVC to generate a first switch signal SW1 and a second switch signal SW2 respectively.

In practical applications, if the duty cycle of the system clock signal CLK is suitably designed to be the same with that of the pulse modulation controlling signal YVC, the system clock signal CLK can be directly used to replace the original pulse modulation controlling signal YVC. Then, the step S14 is performed that the active switch and the output buffering module are turned off according to the first switch signal SW1 and the second switch signal SW2 respectively to make the high-level power source signal VGH start to discharge to form a modulated waveform.

Compared to the prior arts, the gate driver of the invention can not only effectively prevent the damage to the gate driver caused by the pulse current formed when the conventional power source management chip generates a modulated pulse, but also have advantages of using single power source, reducing signal types, and simplifying the design of the power source management chip, therefore, the entire cost of the panel display system can be largely reduced to enhance its competitiveness on the market.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A gate driver, applied in a LCD apparatus, the gate driver comprising:
a pulse modulation controlling module comprising an active switch, when a pulse modulation controlling signal received by the pulse modulation controlling module changes from high-level to low-level, the pulse modulation controlling module turning off the active switch according to the pulse modulation controlling signal, so that a high-level power source signal starting to discharge to have a modulated waveform.

2. The gate driver of claim 1, further comprising:
a first charge pump, for receiving a low-voltage power source and generating the high-level power source signal according to the low-voltage power source; and
a second charge pump, for receiving the low-voltage power source and generating a low-level power source signal according to the low-voltage power source.

3. The gate driver of claim 2, wherein the LCD apparatus comprises a power source management chip, the power source management chip is coupled to the first charge pump and the second charge pump and used to provide the low-voltage power source to the first charge pump and the second charge pump.

4. The gate driver of claim 1, wherein the pulse modulation controlling module further comprises:
a pulse modulation controlling logic switch, when the pulse modulation controlling signal changes from high-level to low-level, the pulse modulation controlling logic switch outputs a first switch signal to the active switch to turn off the active switch.

5. The gate driver of claim 4, further comprising:
an output buffering module, coupled to the pulse modulation controlling logic switch, when the pulse modulation controlling signal changes from high-level to low-level, the pulse modulation controlling logic switch outputs a second switch signal to the output buffering module to turn off the output buffering module.

6. The gate driver of claim 1, wherein the pulse modulation controlling module further comprises a discharging node and a discharging path between the discharging path and ground, when the active switch is turned off, the high-level power source signal starts discharging through the discharging node and the discharging path.

7. The gate driver of claim 6, wherein the pulse modulation controlling module further comprises a discharging resistor, the discharging resistor is located within the discharging path and used to adjust a waveform modulation depth of the high-level power source signal.

8. The gate driver of claim 1, wherein the pulse modulation controlling signal is generated based on the timing of the LCD apparatus.

9. The gate driver of claim 1, wherein the pulse modulation controlling signal can be replaced by a clock signal of the LCD apparatus.

10. The gate driver of claim 9, wherein the clock signal is suitably designed to have the same duty cycle with the pulse modulation controlling signal, so that the clock signal can be used to replace the pulse modulation controlling signal.

11. A method of operating a gate driver, the gate driver being applied in a LCD apparatus, a pulse modulation controlling module of the gate driver comprising an active switch, the method comprising steps of:
the pulse modulation controlling module receiving a pulse modulation controlling signal; and
when the pulse modulation controlling signal changes from high-level to low-level, the pulse modulation controlling module turning off the active switch according to the pulse modulation controlling signal, so that a high-level power source signal starting to discharge to have a modulated waveform.

12. The method of claim 11, wherein the gate driver further comprises a first charge pump and a second charge pump, the first charge pump receives a low-voltage power source and generates the high-level power source signal according to the low-voltage power source, the second charge pump receives the low-voltage power source and generates a low-level power source signal according to the low-voltage power source.

13. The method of claim 12, wherein the LCD apparatus comprises a power source management chip, the power source management chip is used to provide the low-voltage power source to the first charge pump and the second charge pump.

14. The method of claim 11, wherein the pulse modulation controlling module further comprises a pulse modulation controlling logic switch, when the pulse modulation controlling signal changes from high-level to low-level, the pulse modulation controlling logic switch outputs a first switch signal to the active switch to turn off the active switch.

15. The method of claim 14, wherein the gate driver further comprises an output buffering module, when the pulse modulation controlling signal changes from high-level to low-level, the pulse modulation controlling logic switch outputs a second switch signal to the output buffering module to turn off the output buffering module.

16. The method of claim 11, wherein the pulse modulation controlling module further comprises a discharging node and a discharging path between the discharging path and ground, when the active switch is turned off, the high-level power source signal starts discharging through the discharging node and the discharging path.

17. The method of claim 16, wherein the pulse modulation controlling module further comprises a discharging resistor, the discharging resistor is located within the discharging path and used to adjust a waveform modulation depth of the high-level power source signal.

18. The method of claim 11, wherein the pulse modulation controlling signal is generated based on the timing of the LCD apparatus.

19. The method of claim 11, wherein the pulse modulation controlling signal can be replaced by a clock signal of the LCD apparatus.

20. The method of claim 19, wherein the clock signal is suitably designed to have the same duty cycle with the pulse modulation controlling signal, so that the clock signal can be used to replace the pulse modulation controlling signal.
